(19) United States
(12) Patent Application Publication
(10) Pub. No.: US 2007/0010626 A1
(43) Pub. Date: Jan. 11, 2007

(54) Polyethylene compositions

(76) Inventors: Manivakkam J. Shankernarayanan, Cincinnati, OH (US); Michael W. Lynch, West Chester, OH (US)

Correspondence Address: LYONDELL CHEMICAL COMPANY, 3801 WEST CHESTER PIKE, NEWTOWN SQUARE, PA, 19073, US

(21) Appl. No.: 11/178,814

(22) Filed: Jul. 11, 2005

(51) Int. Cl. C08L 23/04

(52) U.S. Cl. 525/240

(57) ABSTRACT

Disclosed is a polyethylene composition. The composition comprises a high molecular weight polyethylene component and a low molecular weight polyethylene component. The low molecular weight component concentrates the long chain branches. The composition of the invention exhibits excellent rheological and physical properties compared with those which concentrate the long chain branches on the high molecular weight component.

### FIELD OF THE INVENTION

The invention relates to polyethylene with targeted long chain branching. More particularly, the invention relates to polyethylene compositions that have long chain branches concentrated on the low molecular weight component.

### BACKGROUND OF THE INVENTION

High molecular polyethylenes have improved mechanical properties but can be difficult to process. On the other hand, low molecular weight polyethylenes have improved processing properties but unsatisfactory mechanical properties. Thus, polyethylenes having a bimodal or multimodal molecular weight distribution are desirable because they can combine the advantageous mechanical properties of high molecular weight component with the improved processing properties of the low molecular weight component.

Methods for making multimodal polyethylenes are known. For example, Ziegler catalysts have been used in producing bimodal or multimodal polyethylene using two or more reactors in series. Typically, in a first reactor, a low molecular weight ethylene homopolymer is formed in the presence of high hydrogen concentration. The hydrogen is removed from the first reactor before the product is passed to the second reactor. In the second reactor, a high molecular weight, ethylene/α-olefin copolymer is made.

Metallocene or single-site catalysts are also known in the production of multimodal polyethylene. For example, U.S. Pat. No. 6,861,415 teaches a multi-catalyst system. The catalyst system comprises catalyst A and catalyst B. Catalyst A comprises a supported bridged indenoindolyl transition metal complex. Catalyst B comprises a supported non-bridged indenoindolyl transition metal complex. The catalyst system produces polyethylenes which have bimodal or multimodal molecular weight distribution.

It is also known that increasing long-chain branching can improve processing properties of polyethylene. For example, WO 93/08221 teaches how to increase the concentration of long chain branching in polyethylene by using constrained-geometry single-site catalysts. U.S. Pat. No. 6,583,240 teaches a process for making polyethylene having increased long chain branching using a single-site catalysts that contain boraaryl ligands.

Multimodal polyethylenes having long chain branching located in the high molecular weight component are known. For example, WO 03/037941 teaches a two-stage process. In the first stage, a polyethylene having high molecular weight and high long chain branching is made. The polyethylene made in the second stage has lower molecular weight and essentially no long chain branching.

While locating long chain branching on the high molecular weight component might provide the multimodal polyethylene with improved processing properties, we found that such multimodal polyethylenes have less desirable mechanical properties such as resistance to environmental stress cracking. New multimodal polyethylenes are needed. Ideally, the multimodal polyethylene would have both improved processing and mechanical properties.

### SUMMARY OF THE INVENTION

The invention is a polyethylene composition with targeted long chain branching. The polyethylene composition comprises a higher molecular weight component and a lower molecular weight component. The lower molecular weight component has a higher concentration of long chain branches. The composition has excellent processing and mechanical properties.

### DETAILED DESCRIPTION OF THE INVENTION

The polyethylene composition of the invention comprises a higher molecular weight polyethylene component and a lower molecular weight polyethylene component. The lower molecular weight component contains a higher concentration of the long chain braches.

Molecular weight and molecular weight distribution can be measured by gel permeation chromatography (GPC). Alternatively, the molecular weight and molecular weight distribution can be indicated by melt indices. Melt index (MI₂) is usually used to measure the molecular weight and melt flow ratio (MFR) to measure the molecular weight distribution. A larger MI₂ indicates a lower molecular weight. A larger MFR indicates a broader molecular weight distribution. MFR is the ratio of the high-load melt index (HLMI) to MI₂. The MI₂ and HLMI can be measured according to ASTM D-1238. The MI₂ is measured at 190° C. under 2.16 kg pressure. The HLMI is measured at 190° C. under 21.6 kg pressure.

Preferably, the higher molecular weight component has an MI₂ less than 0.5 dg/min. More preferably, the higher molecular weight component has an MI₂ within the range of 0.01 to 0.5 dg/min. Most preferably, the higher molecular weight component has an MI₂ within the range of 0.01 to 0.1 dg/min.

Preferably, the lower molecular weight component has an MI₂ greater than or equal to 0.5 dg/min. More preferably, the lower molecular weight component has an MI₂ within the range of 0.5 to 500 dg/min. Most preferably, the lower molecular weight component has an MI₂ within the range of 0.5 to 50 dg/min.

Preferably, the polyethylene composition has a multimodal molecular weight distribution. By “multimodal molecular weight distribution,” we mean that the composition has two or more peak molecular weights. More preferably, the polyethylene composition has a bimodal molecular weight distribution.

The polyethylene composition of the invention has a higher concentration of the long chain branches on the lower molecular weight component. Long chain branching can be measured by NMR, 3D-GPC, and rheology. While NMR directly measures the number of branches, it cannot differentiate between branches which are six carbons or longer. 3D-GPC with intrinsic viscosity and light scattering detection can account for all branches that substantially increase mass at a given radius of gyration. Rheology is particularly suitable for detecting low level of long chain branches.

The concentration of long chain branches can be measured by the long chain branch index (LCBI). LCBI is a rheological index used to characterize low levels of long-chain branching. LCBI is defined as:

$$LCBI = \frac{{η}_{0}^{0.179}}{4.8 \cdot [ η ]} - 1$$

where η₀ is the limiting, zero-shear viscosity (Poise) at 190° C. and [η] is the intrinsic viscosity in trichlorobenzene at 135° C. (dL/g). LCBI is based on observations that low levels of long-chain branching, in an otherwise linear polymer, result in a large increase in melt viscosity, η₀, with no change in intrinsic viscosity, [η]. See R. N. Shroff and H. Mavridis, “Long-Chain-Branching Index for Essentially Linear Polyethylenes,” Macromolecules, Vol. 32 (25), pp. 8454-8464 (1999). Higher LCBI means a greater number of long-chain branches per polymer chain.

Preferably, the higher molecular weight component has an LCBI less than 0.5. More preferably, the higher molecular weight component has essentially no long chain branches.

Preferably, the lower molecular weight component has an LCBI greater than or equal to 0.5. More preferably, the lower molecular weight component has an LCBI within the range of 0.5 to 1.0

Preferred higher molecular weight component includes polyethylenes prepared using a titanium-based Ziegler catalyst. Suitable Ziegler catalysts include titanium halides, titanium alkoxides, and mixtures thereof. Suitable activators for Ziegler catalysts include trialkylaluminum compounds and dialkylaluminum halides such as triethylaluminum, trimethylaluminum, diethyl aluminum chloride, and the like.

Preferred higher molecular weight component includes single-site polyethylenes prepared using a non-bridged indenoindolyl transition metal complex. Preferably, the non-bridged indenoindolyl transition metal complex has the general structure of:

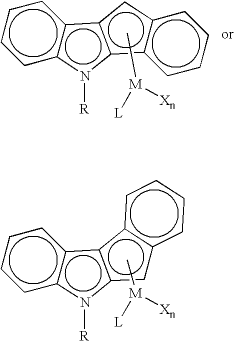

R is selected from the group consisting of alkyl, aryl, aralkyl, boryl and silyl groups; M is a Group 4-6 transition metal; L is selected from the group consisting of substituted or non-substituted cyclopentadienyls, indenyls, fluorenyls, boraarys, pyrrolyls, azaborolinyls, quinolinyls, indenoindolyls, and phosphinimines; X is selected from the group consisting of alkyl, aryl, alkoxy, aryloxy, halide, dialkylamino, and siloxy groups, and n satisfies the valence of M; and one or more of the remaining ring atoms are optionally substituted by alkyl, aryl, aralkyl, alkylaryl, silyl, halogen, alkoxy, aryloxy, siloxy, nitro, dialkyl amino, or diaryl amino groups.

Preferred lower molecular weight component includes low density polyethylenes (LDPE) prepared by free radical polymerization. Preparation of LDPE is well known in the art. LDPE is known to have branched structures.

Preferred lower molecular weight component includes high density polyethylenes prepared using chromium catalyst in the slurry or gas phase process. Chromium catalysts are known. See U.S. Pat. No. 6,632,896. Chromium polyethylenes made by slurry and gas phase process are known to have long chain branched structure, while chromium polyethylenes made by solution process are substantially linear.

Preferred lower molecular weight component includes polyethylenes prepared using a vanadium-based Ziegler catalyst. Vanadium-based Ziegler catalysts are known. See U.S. Pat. No. 5,534,472. Vanadium-based Ziegler polyethylenes are known to have long chain branched structure.

Preferred lower molecular weight component includes single-site polyethylenes prepared using a bridged indenoindolyl transition metal complex. Preferably, the complex has the general structure of I, II, III or IV:

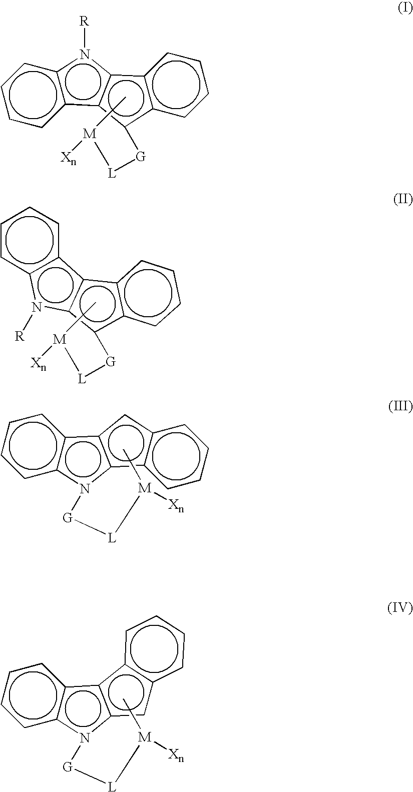

M is a transition metal; G is a bridge group selected from the group consisting of dialkylsilyl, diarylsilyl, methylene, ethylene, isopropylidene, and diphenylmethylene; L is a ligand that is covalently bonded to G and M; R is selected from the group consisting of alkyl, aryl, aralkyl, boryl and silyl groups; X is selected from the group consisting of alkyl, aryl, alkoxy, aryloxy, halide, dialkylamino, and siloxy groups; n satisfies the valence of M; and one or more of the remaining ring atoms are optionally independently substituted by alkyl, aryl, aralkyl, alkylaryl, silyl, halogen, alkoxy, aryloxy, siloxy, nitro, dialkyl amino, or diaryl amino groups.

Preferably, the polyethylene composition comprises a higher molecular weight, high density polyethylene prepared using a titanium-based Ziegler catalyst and a lower molecular weight, high density polyethylene prepared using a chromium catalyst in the slurry or gas phase process.

Preferably, the polyethylene composition comprises a higher molecular weight, high density polyethylene prepared using a titanium-based Ziegler catalyst and a lower molecular weight, high density polyethylene prepared using a single-site catalyst comprising a bridged indenoindolyl transition metal complex.

The polyethylene composition of the invention can be made by thermally mixing the high molecular weight component and the low molecular weight component. The mixing can be performed in an extruder or any other suitable blending equipment.

The polyethylene composition can be made by a parallel multi-reactor process. Take a two-reactor process as an example. The higher molecular weight component is made in a reactor, and the lower molecular weight component is made in another reactor. The two polymers are mixed in either one of the reactors or in a third reactor, prior to pelletization.

The polyethylene composition can be made by a sequential multi-reactor process. Take a two-reactor sequential process as an example. The lower molecular weight component is made in a first reactor. The low molecular weight component is transferred to a second reactor where the polymerization continued to make the high molecular weight component in situ. Alternatively, the high molecular weight component can be made in the first reactor and the low molecular weight component can be made in the second reactor.

The polyethylene composition can also be made by a multi-stage process. Take a two-stage process as an example. The higher molecular weight component can be made in a first stage in a reactor. The polymerization continues in the reactor to make the lower molecular weight component. Alternatively, the lower molecular weight component can be made in the first stage and the higher molecular weight component can be made in the second stage.

Preferably, the polyethylene composition has a weight ratio of the higher molecular weight component to the lower molecular weight component within the range of 10/90 to 90/10. More preferably, the composition has a weight ratio of the higher molecular weight component to the lower molecular weight component within the range of 30/70 to 70/30.

We have surprisingly found that the polyethylene composition of the invention, which is characterized by concentrating the long chain branches in the lower molecular weight component, exhibits excellent rheological properties such as melt elasticity (Er) and physical properties such as environmental stress crack resistance (ESCR), compared to those which concentrate the long chain branches in the higher molecular weight component. ESCR can be determined by ASTM D1693. Typically, the ESCR value is measured in either 10% or 100% Igepal® solution.

Rheological measurements can be performed in accordance with ASTM 4440-95a, which measures dynamic rheology data in the frequency sweep mode. A Rheometrics ARES rheometer is used, operating at 150-190° C., in parallel plate mode under nitrogen to minimize sample oxidation. The gap in the parallel plate geometry is typically 1.2-1.4 mm, the plate diameter is 25 mm or 50 mm, and the strain amplitude is 10-20%. Frequencies range from 0.0251 to 398.1 rad/sec.

ER is determined by the method of Shroff et al. (see U.S. Pat. No. 5,534,472 at col. 10, lines 20-30). Thus, storage modulus (G′) and loss modulus (G″) are measured. The nine lowest frequency points are used (five points per frequency decade) and a linear equation is fitted by least-squares regression to log G′ versus log G″. ER is then calculated from:
ER=(1.781×10⁻³)×G′
at a value of G″=5,000 dyn/cm². As a skilled person will recognize, when the lowest G″ value is greater than 5,000 dyn/cm², the determination of ER involves extrapolation. The ER values calculated then will depend on the degree on nonlinearity in the log G′ versus log G″ plot.

The temperature, plate diameter, and frequency range are selected such that, within the resolution of the rheometer, the lowest G″ value is close to or less than 5,000 dyn/cm². The examples below use a temperature of 190° C., a plate diameter of 50 mm, a strain amplitude of 10%, and a frequency range of 0.0251 to 398.1 rad/sec.

The polyethylene composition of the invention is useful for making articles by injection molding, blow molding, rotomolding, and compression molding. The polyethylene composition is also useful for making films, extrusion coatings, pipes, sheets, and fibers. Products that can be made from the resins include grocery bags, trash bags, merchandise bags, pails, crates, detergent bottles, toys, coolers, corrugated pipe, housewrap, shipping envelopes, protective packaging, wire & cable applications, and many others.

The following examples merely illustrate the invention. Those skilled in the art will recognize many variations that are within the spirit of the invention and scope of the claims.

### EXAMPLE 1

### Polyethylene Composition Having Long Chain Branches Concentrated on the Low Molecular Weight Component

High molecular weight component: MI2: 0.075 dg/min, density: 0.949, LCBI: 0.48; produced by a titanium-based Ziegler catalyst (L 4907, product of Equistar Chemicals).

Low molecular weight component: MI₂: 0.8 dg/min, density: 0.960 g/cm3, long chain branching index (LCBI): 0.58; produced by a chromium catalyst in slurry process (LM 6007, product of Equistar Chemicals).

### COMPARATIVE EXAMPLE 2

### Polyethylene Composition Having Long Chain Branches Concentrated on the High Molecular Weight Component

High molecular weight component: MI₂: 0.1 dg/min, density: 0.950, LCBI: 0.96; produced by a chromium catalyst in slurry process (LP 5100, product of Equistar Chemicals).

Low molecular weight component: MI₂: 0.95 dg/min, density: 0.958 g/cm3, long chain branching index (LCBI): 0.27; produced by a titanium-based catalyst (M 6210, product of Equistar Chemicals).

### EXAMPLE 3

### Polyethylene Composition Having Long Chain Branches Concentrated on the Low Molecular Weight Component

High molecular weight component: MI2: 0.08 dg/min, density: 0.950, LCBI: 0.34; produced by a titanium-based Ziegler catalyst (L5008, product of Equistar Chemicals).

Low molecular weight component: MI₂: 0.8 dg/min, density: 0.960 g/cm3, long chain branching index (LCBI): 0.58; produced by a chromium catalyst in slurry process (LM6007).

### COMPARATIVE EXAMPLE 4

### Polyethylene Composition Having Long Chain Branches Concentrated on the High Molecular Weight Component

High molecular weight component: MI₂: 0.1 dg/min, density: 0.950, LCBI: 0.96; produced by a chromium catalyst in slurry process (LP 5100, product of Equistar Chemicals).

Low molecular weight component: MI₂: 0.70 dg/min, density: 0.960 g/cm3, long chain branching index (LCBI): 0; produced by a titanium-based catalyst (M 6070, product of Equistar Chemicals).

The polyethylene compositions of the above examples are, respectively, made by thoroughly mixing the components in an extruder. The polyethylene compositions are tested for Theological properties and environmental stress crack resistance (ESCR). The ESCR tests are performed on bottles made from the blends. The bottles are made by blow molding process. The results are listed in Table 1. From Table 1, it can be seen that the polyethylene compositions of the invention (Examples 1 and 3), which concentrate the long chain branches on the low molecular weight component, have much higher Er and ESCR than those which concentrate the long chain branches on the high molecular weight component (Comparative Examples 2 and 4).

TABLE 1
RHEOLOGICAL AND ENVIRONMENTAL STRESS CRACK RESISTANCE
PROPERTIES OF THE POLYETHYLENE COMPOSITIONS

| Ex. | LCB | MI₂ | Density | | η₀ × 10⁻⁶ | η₁₀₀ × 10⁻⁴ | Zero Die | Weight Swell | OFI | Bottle ESCR |
|---|---|---|---|---|---|---|---|---|---|---|
| No. | Location | dg/min | g/cm³ | Er | poise | poise | Swell (%) | Die Gap (50 g) | sec⁻¹ | hr |
| 1 | LMW | 0.21 | 0.956 | 3.2 | 2.6 | 1.5 | 261 | 27 | 831 | 39 |
| C2 | HMW | 0.33 | 0.954 | 3.1 | 2.0 | 1.6 | 288 | 15 | 638 | 30 |
| 3 | LMW | 0.20 | 0.957 | 3.4 | 3.3 | 1.4 | 276 | 25 | 993 | 60 |
| C4 | HMW | 0.24 | 0.955 | 2.9 | 1.1 | 2.0 | 267 | 17 | 308 | 8 |

(1) η₀: complex viscosity measured at 0 shear rate.
(2) η₁₀₀: complex viscosity measured at 100 rad/sec.
(3) Die swell is a measure of the diameter extrudate relative to the diameter of the orifice from which it is extruded. Value reported is obtained using an Instron 3211 capillary rheometer fitted with a capillary of diameter 0.0301 inches and length 1.00 inches.
(4) OFI: melt fracture index.

We claim:

1. A composition comprising a higher molecular weight polyethylene component and a lower molecular weight polyethylene component, wherein the low molecular weight component has a higher concentration of long-chain branches than the high molecular weight component.

2. The composition of claim 1, wherein the higher molecular weight component has a melt index (MI₂) less than 0.5 dg/min and a long chain branching index (LCBI) less than 0.5, and the lower molecular weight component has an MI₂ greater than or equal to 0.5 dg/min and an LCBI greater than or equal to 0.5.

3. The composition of claim 1, wherein the higher molecular weight component has an MI₂ within the range of 0.01 to 0.5 dg/min and has essentially no long chain branches, and the lower molecular weight component has an MI₂ within the range of 0.5 to 50 dg/min and an LCBI within the range of 0.5 to 1.

4. The composition of claim 1, wherein the higher molecular weight component is selected from the group consisting of polyethylenes prepared using a titanium-based Ziegler catalyst and polyethylenes prepared using a non-bridged indenoindolyl ligand-containing single-site catalyst.

5. The composition of claim 1, wherein the lower molecular weight component is selected from the group consisting of polyethylenes prepared by free radical polymerization, polyethylenes prepared using a chromium catalyst in the slurry or gas phase, polyethylenes prepared using vanadium-based Ziegler catalyst, and polyethylenes prepared using a bridged indenoindolyl ligand-containing single-site catalyst.

6. The composition of claim 1, wherein the higher molecular weight component is a high density polyethylene prepared using a titanium-based Ziegler catalyst and the lower molecular weight component is a high density polyethylene prepared using a chromium catalyst in the slurry or gas phase.

7. The composition of claim 1, wherein the higher molecular weight component is a high density polyethylene prepared using a titanium-based Ziegler catalyst and the lower molecular weight polyethylene is a high density polyethylene prepared using a bridged indenoindolyl ligand-containing single-site catalyst.

8. The composition of claim 1, wherein the higher molecular weight component is a high density polyethylene prepared using a titanium-based Ziegler catalyst and the lower molecular weight polyethylene is a high density polyethylene prepared using a vanadium-based Ziegler catalyst.

9. The composition of claim 1 having a multimodal molecular weight distribution.

10. The composition of claim 1 having a bimodal molecular weight distribution.

11. The composition of claim 1 having a weight ratio of the higher molecular weight component to the lower molecular weight component within the range of 10/90 to 90/10.

12. The composition of claim 1 having a weight ratio of the higher molecular weight component to the lower molecular weight component within the range of 30/70 to 70/30.

13. A method for making the composition of claim 1, said method comprising thermally mixing the higher molecular weight component and the lower molecular weight component.

14. A method for making the composition of claim 1, said method comprising producing the higher molecular weight component and the lower molecular weight component in two or more parallel reactors and then blending them.

15. A method for making the composition of claim 1, said method comprising producing the higher molecular weight component and the lower molecular weight component sequentially in two or more reactors.

16. A method for making the composition of claim 1, said method comprising producing the higher molecular weight component and the lower molecular weight component in two or more stages.

17. An article comprising the composition of claim 1.

18. A film comprising the composition of claim 1.

19. A pipe comprising the composition of claim 1.
